(19) United States
(12) Patent Application Publication
(10) Pub. No.: US 2006/0041483 A1
(43) Pub. Date: Feb. 23, 2006

(54) Commercial negotiation system and method

(76) Inventors: Yury Bogomolsky, Vista, CA (US); John M. Hoffe, San Marcos, CA (US)

Correspondence Address: FISH & RICHARDSON, PC, P.O. BOX 1022, MINNEAPOLIS, MN, 55440-1022, US

(21) Appl. No.: 10/924,545

(22) Filed: Aug. 23, 2004

(51) Int. Cl. G06Q 30/00

(52) U.S. Cl. 705/26

(57) ABSTRACT

Systems and methods for conducting negotiations of commercial transactions. A system includes one or more clients connected to a network, and a negotiation system connected to the network and configured to communicate with the one or more clients. The negotiation system includes a server configured for receiving an offer for the item from the one or more clients, and configured for generating a response for sending to the one or more clients. The negotiation system further includes a data engine configured for dynamically gathering data from one or more information sources, and an analysis engine configured for generating a value associated with the item based on the data from the one or more information sources. The negotiation system further includes a decision engine configured for evaluating the offer based on the value associated with the item, and for providing a result of the evaluation to the server.

### BACKGROUND

Some conventional electronic commerce systems allow sellers and buyers to sell and purchase items over a network via various forms of electronic communication. Such electronic commerce systems have automated, and accelerated, commercial transactions and are now ubiquitous in most markets.

Typical electronic commerce systems, though, even those employing an “auction” environment, rely on static parameters in determining the terms of a sale of an item. For instance, some auction systems accept the highest priced bid over a given period of time to set the price at which an item is to be sold. Other electronic commerce systems state a particular price, which the buyer can determine whether or not to accept.

Conventional electronic commerce systems do not provide a dynamic value (real or perceived) for an item, nor do they dynamically re-evaluate the progress of a negotiation related to a commercial transaction for an item.

### SUMMARY

This document describes a system and method for negotiating a commercial transaction, employing techniques for using a dynamically-generated value of an item as well as dynamically re-evaluating the progress of the negotiation process. In accordance with one embodiment, a method includes the steps of receiving an offer for an item over a network, and evaluating the offer based on a value associated with the item. The value is dynamically generated based on data from one or more information sources.

In accordance with another embodiment, a system for negotiating a commercial transaction for an item is described herein. The system includes one or more clients connected to a network, and a negotiation system connected to the network and configured to communicate with the one or more clients. The negotiation system includes a server configured for receiving an offer for the item from the one or more clients, and configured for generating a response for sending to the one or more clients. The negotiation system further includes a data engine configured for dynamically gathering data from one or more information sources, and an analysis engine configured for generating a value associated with the item based on the data from the one or more information sources. The negotiation system further includes a decision engine configured for evaluating the offer based on the value associated with the item, and for providing a result of the evaluation to the server.

The details of one or more embodiments are set forth in the accompanying drawings and the description below. Other features, objects, and advantages will be apparent from the description and drawings, and from the claims.

### BRIEF DESCRIPTION OF THE DRAWINGS

These and other aspects will now be described in detail with reference to the following drawings.

FIG. 1 is a flowchart of an electronic commerce process.

FIG. 2 is a flowchart of an electronic commerce transaction negotiation process according to an exemplary embodiment.

FIG. 3 is a flowchart of a dynamic optimal value determination process.

FIG. 4 is a flowchart of a response process for a negotiated transaction.

FIG. 5 is a flowchart of an alternative exemplary embodiment of a negotiation process.

FIG. 6 depicts a system for executing a negotiation process according to one embodiment.

Like reference symbols in the various drawings indicate like elements.

### DETAILED DESCRIPTION

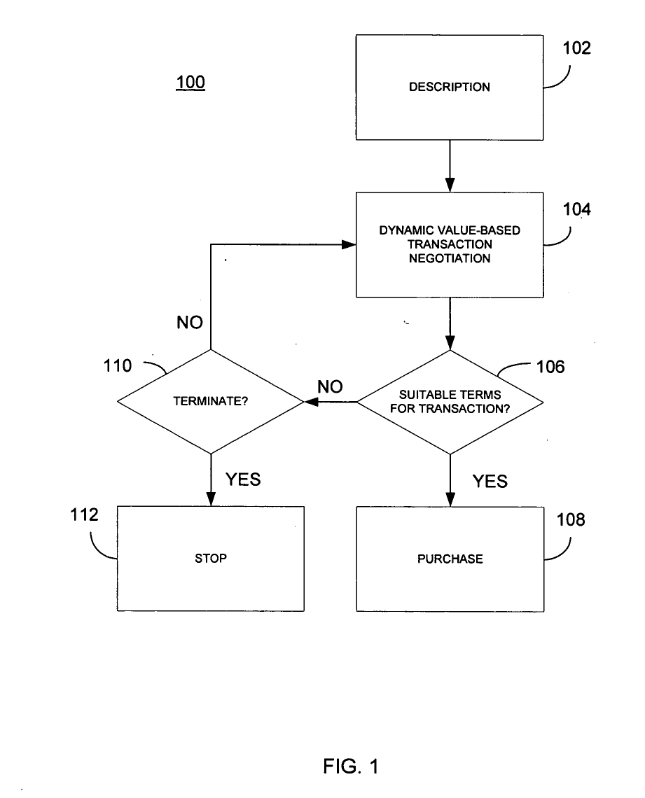

FIG. 1 is a flowchart of an electronic commerce process 100. The electronic commerce process 100 can be part of a web-based auction such as eBay, uBid, Bidz, Yahoo Auctions, Amazon Auction, etc. The electronic commerce process 100 can be executed with other online or electronic commercial transactions, particularly those conducted over a network. At step 102, a description of an item is provided. The description may be provided by a program running on a server and communicated to a client device (hereafter, “client”) over a network for a user/buyer. The description can include text, graphics, pictures, video, sound or any other medium employed by the client to describe the item, which description can be presented on the client. The graphical user interface can be generated in a program running on the client such as a browser or other local client application. The item described can be a good, a product, a service, or any other merchantable item or group of items.

At step 104, a dynamic value-based transaction negotiation process for the item is executed. The value-based transaction negotiation process dynamically generates a value for the item based on one or more parameters, including but not limited to, system settings, input from a third party system, user inputs, the item description, general human behavioral patterns or specific user behavioral patters, market information related to the item such as shelf life, weather, season, sales history, and other conditions that can affect the perceived or real value of the item. The value may include a price, a time window during which the item may be purchased, a specification of a preferred payment mechanism, or other factors or options. A value can be generated and dynamically updated for each specific user, as will be explained in further detail below.

At step 106, a determination is made whether a user has provided suitable terms for the transaction, after one or more iterations of the value-based transaction negotiation process of step 104. If yes, a purchase program is executed at step 108 by which a user can purchase or otherwise provide bargained-for consideration for the item. The purchase program at step 108 is preferably conducted on a computer and over a network. If no, a determination is made at step 110 whether to exit from the electronic commerce process 100. If yes, the electronic commerce process 100 is stopped at step 112. If no, the value-based transaction negotiation process of step 104 can be executed again, as many times as it takes to either reach a suitable result (i.e. purchase 108) or a decision to terminate or postpone the electronic commerce process 100.

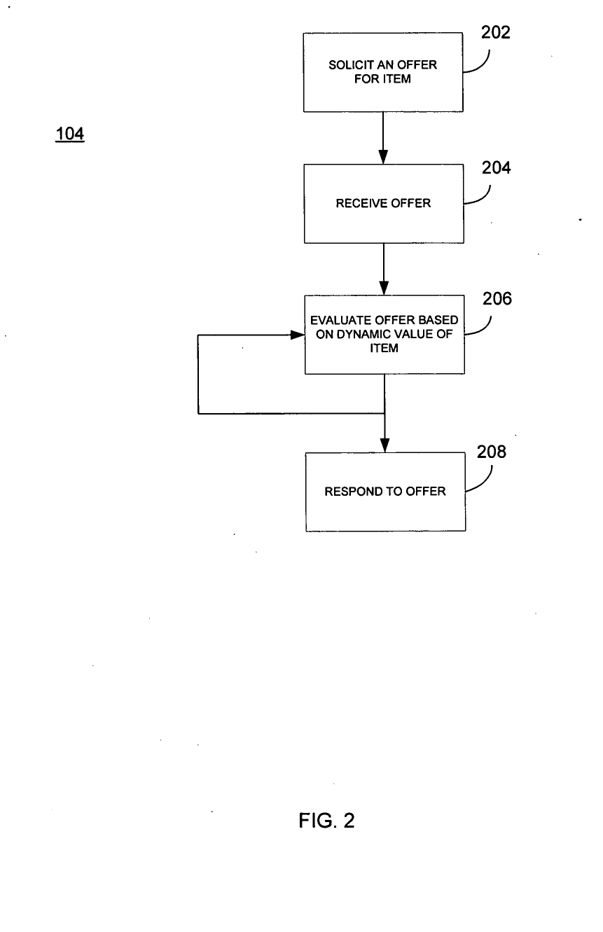

FIG. 2 is a flowchart of an electronic commerce transaction negotiation process 104 according to one exemplary embodiment executed by a negotiation system. At step 202, an offer for an item is solicited or requested. The solicitation or request can be conveyed textually such as in “make an offer,” or graphically by a user input window or box, or any other presentation mechanism supported by the client. The solicitation or request for the offer can be provided in a predefined portion of a web page or a graphical user interface for a user. At step 204, an offer is received. The offer is preferably represented in a user input provided by the user. For example, a user may use a keyboard to type an offer price into a web page or any other client application to be sent to a program running on a network.

At step 206, the offer is evaluated based, at least in part, on a dynamically-generated value of the item. The dynamically-generated value represents a current optimal or near-optimal, and acceptable, term corresponding to a perceived or real value of the item, near or at that moment in time. The evaluation leads to a response to the offer at step 208. The response can include, without limitation, acceptance, rejection, or counter-offer to the offer. The response can also include a revision of the value of the item and an invitation to the user to make another offer. The response is explained in further detail below.

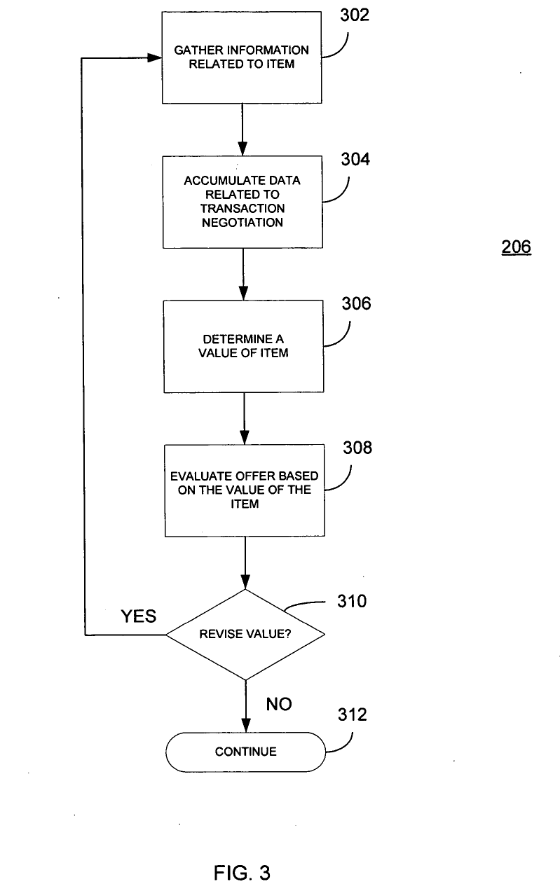

FIG. 3 is a flowchart of a dynamic value determination process 206. At step 302 information related to the item is gathered. The information can be obtained from one or more websites, servers, databases or other information repositories or sources in or external to the negotiation system as described below. The information can include any information related to the item, such as current market price, manufacturing price, appraised value, inventory data, quality data, product or service descriptions, etc. For example, a website such as Amazon.com can be accessed and researched to obtain a current retail price of an item. As another example, if the negotiation process is being executed in the context of an eBay auction, the eBay environment can be searched for determining a current competitive price of the same or similar items. At step 304, data related to the transaction negotiation is accumulated. The data can include, without limitation, historical data of a user's purchases such as past prices paid for similar or dissimilar items, buying habits, negotiation habits such as length of time between successive offers or price increments offered by the user. The data can also include a user identifier for use in accumulated and stored historical data.

The gathered information and accumulated data is selectively analyzed and processed for dynamic generation or revision of a value, as determined at step 306. This value can account for, among other parameters, a particular user's willingness, ability or desire to pay a certain price for the item and/or a particular seller's willingness, ability or desire to sell the item for a certain price. The value can be instantaneously and dynamically adjusted or revised, as decided at step 310, based on any number of factors such as current or expected market conditions, competitive forces, external events, or data related to the negotiation process itself. If the value is to be revised, each or selected ones of the steps 302, 304, 306 and/or 308 may be executed again, for as many times as it takes to reach a satisfactory state, or to make a decision to end or postpone the negotiation process. If no revision is to be made, the transaction negotiation process 206 continues at step 312.

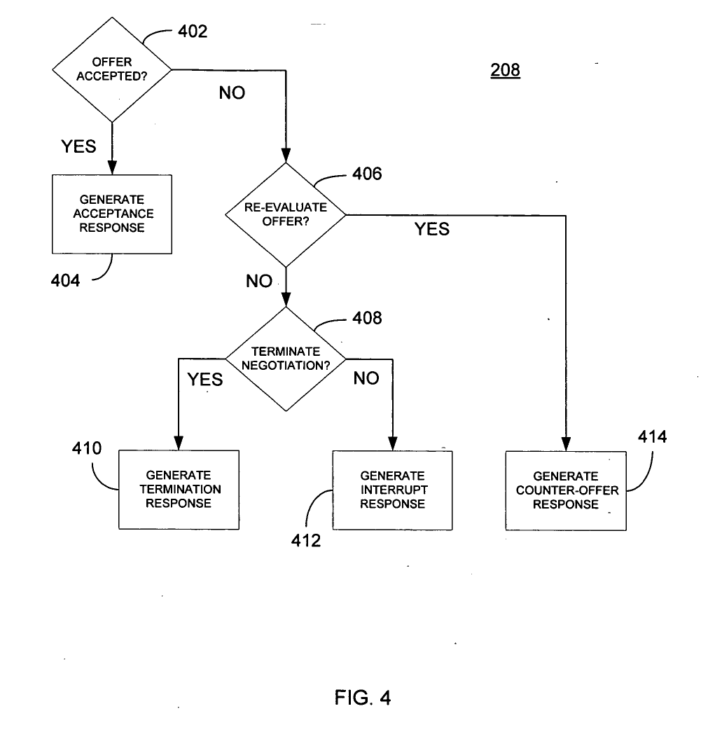

FIG. 4 is a flowchart of a response process 208 for a negotiated transaction. At step 402 a determination is made whether an offer from a user for an item is acceptable. The determination is made based on an evaluation of the offer against the dynamically-generated value of the item. If yes, at step 404 an acceptance response is generated. The acceptance response is communicated to the buyer. For example, the acceptance response can be communicated in a window defined in a display connected with the client, in a text message that that informs the buyer that his or her offer has been accepted, and a link or instructions to a purchase program can be provided.

If no, at step 406 a determination is made whether the offer will be re-evaluated. If no, a determination is made at step 408 whether the negotiation process will be terminated. If yes, at step 410 a termination response is generated to indicate to the user that the negotiation is being stopped. If no, at step 412, an interrupt response is generated to indicate to the user that the negotiation is being temporarily interrupted. The interruption can be used to re-evaluate the negotiation state and perhaps revisit the offer re-evaluation decision at step 406, or to obtain further information or data with which to resume the negotiation. The interruption can also be used to enforce market condition changes onto the buyer as pressure for the buyer to make a decision. For instance, in an eBay environment, postponing the negotiation means that more bids may be made for the item, increasing the chances for an acceptable offer by the buyer or another buyer. If the negotiation is interrupted, a negotiation state is stored, to include a user identifier, previously-made offers, and other negotiation-related data.

If it is determined at step 406 to re-evaluate the offer, then at step 414 a counter-offer response is generated. The counter-offer response can include a counter-offer for presentment to the user. Such a counter-offer can include, without limitation, a suggested or acceptable price or other term, an offer to sell a different item in combination with the originally-offered item, or other cross- or up-sale negotiation paths.

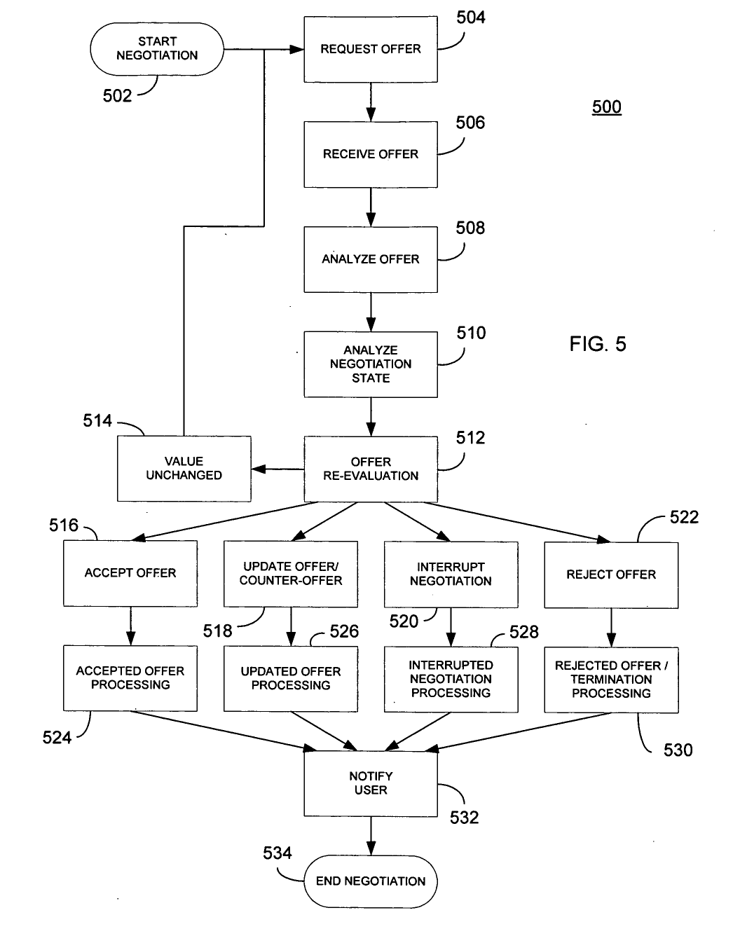

FIG. 5 is a functional flow diagram of a negotiation system and process 500 in accordance with an alternative exemplary embodiment. At block 502, a session of a negotiation system is started. This can occur by a user interface to the negotiation system being provided to an electronic commerce webpage for example, or by a server providing an instance of a negotiation program for access by a client. At block 504, the negotiation system requests an offer to be made on an item. The item can be a product, good, service or other merchantable item or group of items. In one example, the negotiation system defines an interface proximate to a description of the item, and presents text of “make an offer for this item” near or in the interface.

At block 506 the negotiation system receives an offer. The offer can be communicated from a client to the negotiation system, as provided to the client by a user. For example, a user can type into a box a number representing an offer price for the item, and select a control to have the number transmitted to the negotiation system. At block 508, the negotiation system analyzes the offer, i.e. determines a meaning or context of the offer. At block 510, the negotiation system analyzes a negotiation state. For instance, the offer is compared to a first value calculated for the item by the negotiation system based on a number of parameters. If the offer is too low and below a dynamically-defined threshold, the negotiation system will generate a negotiation state to indicate that the offer will not be acceptable. If the offer is too low yet above the dynamically-defined threshold, the negotiation state can indicate that the offer is unacceptable but potentially near revision for acceptability. The negotiation state is used to determine a next step or move by the negotiation system to respond to the offer.

In one exemplary embodiment, the negotiation state is used to determine whether the offer will be re-evaluated at block 512. For example, the negotiation engine can adjust a value generated for the item, seek a better offer from the user, provide a counter-offer to the user for the item or a different item, or other offer-based evaluation. In one scenario, the value of the item, and therefore an acceptable price for which it can be sold, can be kept unchanged at block 514. In this case, a new offer is requested from a buyer at block 504.

Alternate response functions for offer re-evaluation are depicted in blocks 516, 518, 520, and 522. If the negotiation state indicates that the offer is acceptable, i.e. corresponding to a generated value of the item, the negotiation system accepts the offer at block 516. The negotiation system processes the accepted offer at block 524. For example, the negotiation system communicates to a client a message at block 532 that the offer has been accepted, and may provide a link for the user to navigate to a purchasing program.

If the negotiation state indicates that the offer is unacceptable but can be countered, the negotiation system updates the offer and/or presents a counter offer at block 518, which updated offer or counter offer is processed at block 526. This processing can include the negotiation engine finding a complementary item to offer for sale along with the original item, and soliciting a new offer for the combined items. Alternatively, the negotiation system may communicate a counter offer of the terms for the item, taking into account the buyers previous offer(s) and current marketplace information and conditions. Many other responses and response processing are possible.

If the negotiation state indicates that the negotiation process for an item has stalled or an acceptable offer is not imminently forthcoming, particularly after multiple iterations or received offers, the negotiation system can interrupt the negotiation at block 520. The negotiation system will store the negotiation state and related information, including but not limited to user information, historical offer information, historical market information, etc., and impose a time period after which the negotiation can resume. For example, the negotiation, with knowledge of a user ID or client ID, may block a user from accessing the negotiation process for the item until the time period has expired. The interrupt is processed at block 528.

If the negotiation state indicates that the negotiation process should be abandoned, such as if the negotiation system determines that the buyer is neither nor capable of making an acceptable offer, or if the item is no longer available for sale, etc., the negotiation system will reject the offer at block 522 and the negotiation is terminated at block 530. An indication of the negotiation state at block 510, the determination to re-evaluate the offer at block 512, or any of the other actions described above can be communicated to a user at block 532. The communication can include a text message, graphic, or other signal. For example, the communication is sent to the client used by the buyer. At block 534, the negotiation system ends the negotiation.

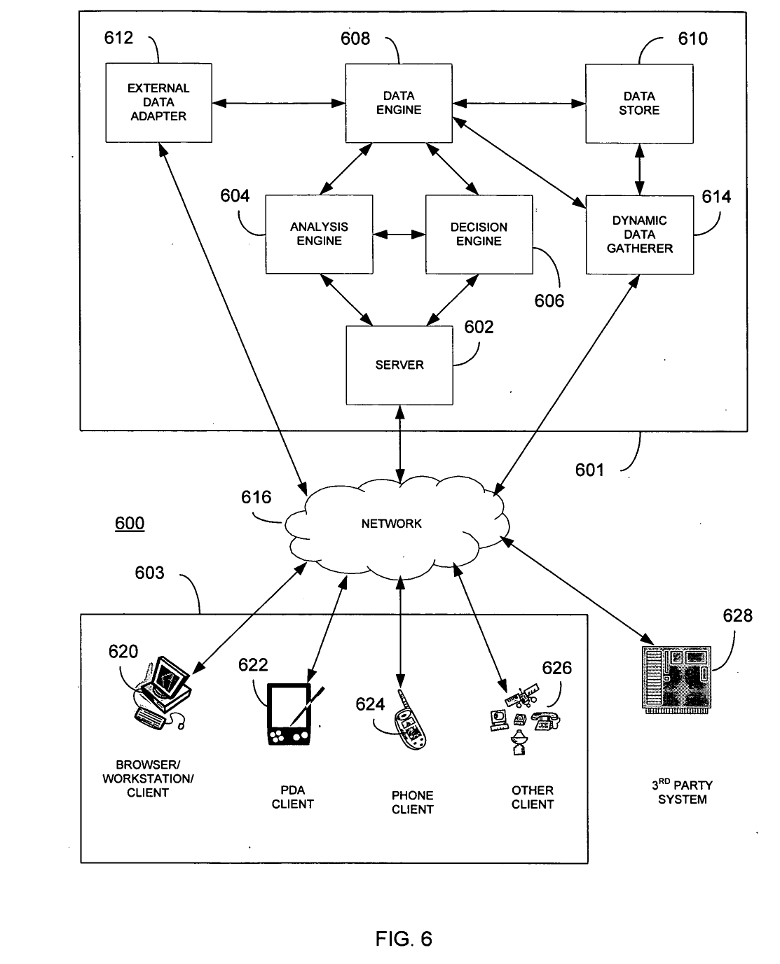

FIG. 6 depicts a system 600 for executing a negotiation process according to one embodiment. The system 600 includes a negotiation system 601 that communicates with a number of clients 603 through a network 616. In an exemplary embodiment, the system 600 is implemented as a number of interconnected software components such as servers, engines, and clients. Alternatively, one or more components of the system 600 can be embodied in hardware such as integrated circuits, or a combination of hardware and software (i.e. firmware). The network 616 represents the Internet, a wide area network (WAN), local area network (LAN), wireless communication network, or any other type of data-carrying communication network.

The negotiation system 601 includes a server 602 for gathering the data needed to produce the solicitation, response, or counter-offer, and present these to the corresponding buyer user through the network 616. An analysis engine 604 communicates with the server 602 and is configured for producing analysis-based data to be further presented to a decision engine 606 or directly to the server 602. Examples of the analysis-based data include a reasonable initial acceptable price of an item that is generated at the start of a negotiation process.

The decision engine 606 communicates with both the server 602 and analysis engine 604, and is configured for making decisions to be used by the server 602 in the course of a negotiation process. Such decisions can be driven by any number of decision-making algorithms stored in a library accessible by the decision engine 604. The library (not shown) can be located in the decision engine 602, in the decision engine 606, or in any other data store accessible by the negotiation system 601. The decision engine 606 selects one or more decision-making algorithms based on various parameters, including but not limited to offers presented by a buyer, static historical data, dynamic market data, data from third party systems 628 such as websites or other online information sources, and data provided by the analysis engine 604.

A data engine 608 communicates with both the analysis engine 604 and decision engine 606, and is configured for provided access for the analysis engine 604 and decision engine 606 to other data sources in or external to the negotiation system 601. In one embodiment, these other data sources include a data store 610, a dynamic data gatherer 614, and an external data adapter 612. The data store 610 provides persistent storage for the historical, analytical, and any other type of static data, i.e. data that is not acquired only in association with a present offer submitted by a buyer. The dynamic data gatherer 614 is configured to dynamically gather data from a variety of sources based on a request associated with an offer or a negotiation process. These data sources include, without limitation, external databases, websites, web services, etc. and can be accessed via the network 616 Data from these sources is gathered and presented to the data engine 608, which routes data to the requesting component, and decides whether to store the data to the data store 610. The external data adapter 612 provides access from third party systems 628 for providing data through the network 616 to the negotiation system 601 directly.

The clients 603 represent any device capable of communicating with the network 616 and negotiation system 601 for conducting a negotiation process in real-time or near real-time. Examples of clients 603 include a browser 620 running on a client workstation such as a desktop or laptop computer, a personal digital assistant 622 or other handheld computing device, a phone 624 such as a wireless phone running a wireless browser client program, or other client device 626 that can communicate data with the network 616.

Although a few embodiments have been described in detail above, other modifications are possible. The logic flows depicted in FIGS. 1-5 do not require the particular order shown, or sequential order, to achieve desirable results, and may be executed in an order other than that shown. Other embodiments may be within the scope of the following claims.

1. A computer-implemented method for negotiating a commercial transaction, the method comprising:
receiving an offer for an item; and
evaluating the offer based on a value associated with the item, wherein the value is dynamically generated based on data from one or more information sources.

2. A method in accordance with claim 1, further comprising generating a response in accordance with an evaluation of the offer based on the value.

3. A method in accordance with claim 1, further comprising sending a solicitation for the offer to a client.

4. A method in accordance with claim 3, wherein the solicitation includes a description of the item.

5. A method in accordance with claim 1, further comprising generating the value associated with the item.

6. A method in accordance with claim 5, wherein generating the value further comprises gathering data from the one or more information sources.

7. A method in accordance with claim 6, wherein the data includes historical negotiation data associated with the commercial transaction.

8. A method in accordance with claim 6, wherein the data includes market data related to the item.

9. A method in accordance with claim 6, wherein the data includes data that affects a real or perceived value of the item.

10. A method in accordance with claim 6, wherein the one or more information sources is selected from a group of information sources comprised of: a website, a database, and a web service.

11. A method in accordance with claim 2, wherein generating a response includes generating a counter-offer related to the item.

12. A method in accordance with claim 1, further comprising revising the value associated with the item based on the evaluation of the offer and/or new data from one or more information sources.

13. A method in accordance with claim 12, further comprising sending a solicitation for a new offer to a client.

14. A method in accordance with claim 2, wherein generating a response includes postponing the negotiation of the commercial transaction.

15. A method in accordance with claim 2, wherein generating a response includes terminating the negotiation of the commercial transaction.

16. A method in accordance with claim 1, wherein evaluating the offer includes determining whether the offer is acceptable based on the value.

17. A method in accordance with claim 16, further comprising:
if the offer is acceptable based on the value, generating a response to represent an acceptance of the offer; and
if the offer is not acceptable based on the value, generating a response to represent that the offer is declined.

18. A computer program product, tangibly embodied in an information carrier, the computer program product comprising instructions operable to cause a data processing apparatus to:
dynamically generate a value associated with an item based on data from one or more information sources;
send a solicitation for an offer to a client;
receive the offer from the client; and
evaluate the offer based on the value associated with the item.

19. A computer program product in accordance with claim 18, further comprising instructions operable to cause the data processing apparatus to generate a response in accordance with an evaluation of the offer base on the value.

20. A computer program product in accordance with claim 18, the value is revised based on new data from the one or more information sources.

21. A system for negotiating a commercial transaction for an item, the system comprising:
one or more clients connected to a network; and
a negotiation system connected to the network and configured to communicate with the one or more clients, the negotiation system comprising:
a server configured for receiving an offer for the item from the one or more clients, and configured for generating a response for sending to the one or more clients;
a data engine configured for dynamically gathering data from one or more information sources;
an analysis engine configured for generating a value associated with the item based on the data from the one or more information sources; and
a decision engine configured for evaluating the offer based on the value associated with the item, and for providing a result of the evaluation to the server.
